(19) United States
(12) Patent Application Publication
(10) Pub. No.: US 2018/0165667 A1
(43) Pub. Date: Jun. 14, 2018

(54) CONTROL OF PERMISSIONS FOR MAKING TRANSACTIONS

(71) Applicant: Mastercard International Incorporated, Purchase, NY (US)

(72) Inventors: Elson Rodrigues, Mumbai (IN); Piyush Sharma, Pune (IN)

(73) Assignee: Mastercard International Incorporated, Purchase, NY (US)

(21) Appl. No.: 15/833,401

(22) Filed: Dec. 6, 2017

(30) Foreign Application Priority Data
Dec. 9, 2016 (SG) 10201610340W

(51) Int. Cl. G06Q 20/20; G06Q 20/42; G06Q 20/32; G06Q 20/38; G06Q 30/06; H04L 29/08; H04W 72/04

(52) U.S. Cl. CPC G06Q 20/206; G06Q 20/42; G06Q 20/322; G06Q 20/382; H04W 88/02; H04L 67/10; H04L 67/18; H04W 72/0426; G06Q 30/06

(57) ABSTRACT

Disclosed is a computer network for controlling permission for making transactions over a wireless network. The computer system comprises a database, a merchant terminal and an available base station. The database is associated with a processor, and the merchant terminal and available base station each comprise at least one processor and at least one memory including computer program code. The computer program code of the merchant terminal and the available base station collectively configure the computer network to, with the respective at least one processor, register, in the database a terminal identifier (terminal ID) of the merchant terminal; and, in association with the terminal ID, and a permitted base station identifier (permitted station ID) for each of one or more permitted base stations through which the merchant terminal may make transactions. They further configure the computer network to send, from the merchant terminal to the available base station, a request to access the available base station to make a transaction over the wireless network, the request comprising the terminal ID, determine if the available base station has a permitted station ID stored in association with the terminal ID and, if so, permit the merchant terminal to access the available base station to make the transaction or, if not, deny the merchant terminal access to the available base station for the purpose of making the transaction.

### CROSS-REFERENCE TO RELATED APPLICATIONS

This application claims the priority benefit of Singapore Patent Application No 10201610340W, filed Dec. 9, 2016, which is incorporated herein by reference in its entirety.

### TECHNICAL FIELD

The present disclosure relates to a system for controlling permissions to make transactions, and computer processes performed on such as system. The system disclosed herein can be applied to control permission to makes transactions over networks, such as mobile networks and other wireless networks.

### BACKGROUND

Merchant terminals such as point-of-sale (POS) machines are commonly used to facilitate purchase of goods and services (collectively a ‘product’ or ‘products’). They enable use of credit and debit facilities with the merchants with whom they are registered.

It is also common for merchant terminals to use wireless transmission to communicate with a network through which transactions for products are made. That communication can be between a merchant terminal and an in-store wireless transceiver, or between a merchant terminal and a wireless network.

Some merchant terminals are capable of direct connection with a mobile network, through base stations of the mobile network. This enables the merchant terminal to be registered at one premises of a merchant, and used at another of the merchant's premises. The merchant terminal simply connects to the nearest base station of the mobile or wireless network, and makes the necessary transactions through that base station. This technology has enabled the development of mobile merchant terminals (e.g. wireless POS terminals) that can be readily transported between locations to service demand fluctuations or to rapidly replace a broken terminal at a particular location.

There are a number of dangers with mobile merchant terminals. The same terminal can be used to make transactions at premises that do not belong to the merchant. For example, a mobile POS terminal may be used to fraudulently receive funds for transactions at a different merchant's store. Also, a mobile POS terminal may be carried to a different tax jurisdiction or country, so that transactions made in the jurisdiction or country appear to have been serviced by the merchant in the merchant's home country (or wherever the terminal was purchased). Thus the merchant can register the mobile terminal in a low-tax jurisdiction, carry the terminal to a high-tax jurisdiction whereat transactions are made, and those transactions will appear to have been made in the low-tax jurisdiction yet inventory costs will be incurred in the high-tax jurisdiction.

It would be useful to provide a system or method that reduces the likelihood of fraudulent usage of merchant terminals and, in particular, mobile merchant terminals.

### SUMMARY

The present disclosure provides a computer network for controlling permission for making transactions over a wireless network, the computer network comprising:

a database; and

a merchant terminal; and

an available base station in communication with the merchant terminal,

the database being associated with a processor, and the merchant terminal and available base station each comprising:

at least one processor; and

at least one memory including computer program code;

the computer program code of the merchant terminal and the available base station collectively configure the computer network to, with the respective at least one processor:
register, in the database:
   a terminal identifier (terminal ID) of the merchant terminal; and, in association with the terminal ID,
   a permitted base station identifier (permitted station ID) for each of one or more permitted base stations through which the merchant terminal may make transactions;
send, from the merchant terminal via the available base station, a request to make a transaction over the wireless network, the request comprising the terminal ID and an ID of the available base station;
determine if the ID of the available base station matches at least one permitted station ID stored in association with the terminal ID; and
if so, permit the merchant terminal to make the transaction.

Also disclosed herein is a computer process for controlling permission for making transactions over a wireless network, comprising
registering, in a database:
   a terminal identifier (terminal ID) of a merchant terminal; and, in association with the terminal ID,
   a permitted base station identifier (permitted station ID) for each of one or more permitted base stations through which the merchant terminal may make transactions;
sending, via the merchant terminal to an available base station, a request to make a transaction over the wireless network, the request comprising the terminal ID and an ID of the available base station;
determining if the ID of the available base station matches at least one permitted station ID stored in association with the terminal ID; and
if so, permitting the merchant terminal to make the transaction.

An acquirer processing system for controlling permission for making transactions over a wireless network, comprising:

a database; and

at least one processor;

wherein the at least one processor is configured to:

register, in the database:
a terminal identifier (terminal ID) of a merchant terminal; and, in association with the terminal ID,
a permitted base station identifier (permitted station ID) for each of one or more permitted base stations through which the merchant terminal may make transactions;

receive, from the merchant terminal via an available base station, a request to make a transaction over the wireless network, the request comprising the terminal ID and an ID of the available base station;

determine if the ID of the available base station matches at least one permitted station ID stored in association with the terminal ID; and if so, permit the merchant terminal to make the transaction.

### BRIEF DESCRIPTION OF DRAWINGS

Some embodiments will now be described by way of non-limiting example only, with reference to the accompanying drawings in which:

FIG. 1 illustrates a method for controlling permission for making transactions over a wireless network.

FIG. 2 illustrates relationships between terminals and permitted base stations;

FIG. 3 illustrates the relationship between terminals and available base stations;

FIG. 4 is a network system for performing the method of FIG. 1; and

FIG. 5 is an example computer system for performing various steps of the method of FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

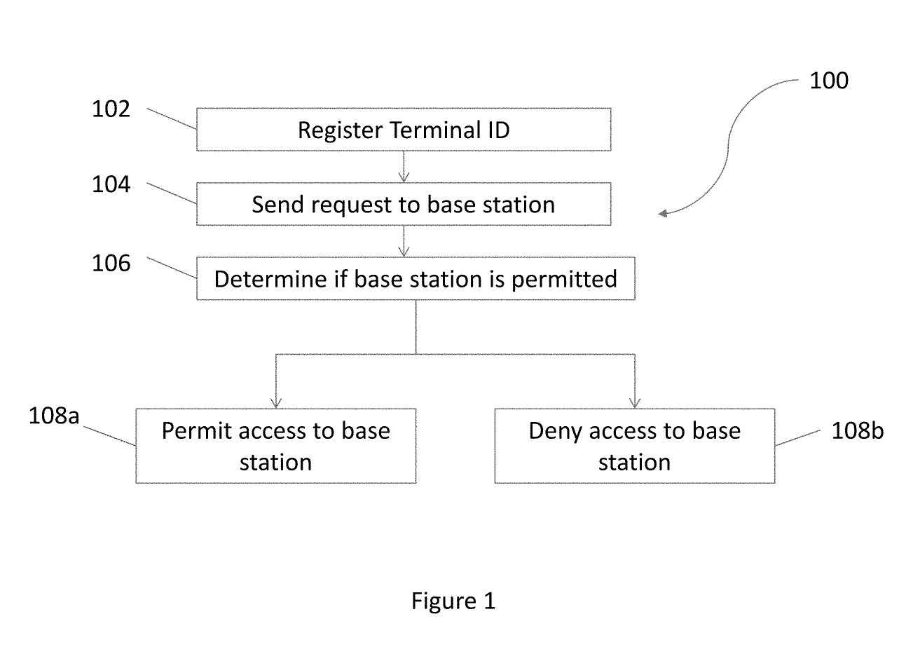

FIG. 1 illustrates a method 100 for controlling permission for making transactions over a wireless network. The method 100 broadly comprises:
Step 102: registering a terminal ID and one or more permitted station IDs.
Step 104: sending a permission request to an available base station.
Step 106: determining if the available base station has the, or one of the, permitted station IDs.
Step 108a: permitting the merchant terminal to access the available base station.
Step 108b: denying the merchant terminal access to the available base station.

Step 102 involves registering, in a database:
a terminal identifier (terminal ID) of a merchant terminal; and, in association with the terminal ID,
a permitted base station identifier (permitted station ID) for each of one or more permitted base stations through which the merchant terminal may make transactions. The effect of this registration is that the merchant terminal is only able to make transactions using base stations with which it has been registered.

The terminal ID is the identifier of a merchant terminal, such as a POS terminal or mobile POS terminal. The identifier will typically be unique to the terminal, so that receipt of the terminal ID by, for example, a server on a mobile telecommunications network will enable that server to uniquely identify the merchant terminal sending the terminal ID.

The terminal ID is stored in association with one or more station IDs. Each station ID is an identifier, usually a unique identifier, of a base station of a wireless (e.g. mobile telecommunications) network. Each permitted station ID is the relevant station ID for each of one or more base stations with which the merchant terminal is permitted to be used (permitted base stations). The one or more permitted station IDs are registered with the terminal ID so that a check can be made to ensure the merchant terminal is only operational to make transactions when those transactions are made through a permitted base station.

If a merchant terminal endeavours to make a transaction through a base station that is not registered in association with the terminal ID (a non-permitted base station), then the relevant merchant terminal will be declined access to the non-permitted base station for the purpose of making transactions. In other words, the merchant terminal may be locked (e.g. by a service engineer or by an over-the-air update) to a particular one or a particular one or more cell identifiers (Cell IDs or CIDs—i.e. base station ID) being the identifiers of cells of a cellular communications network, where each cell is serviced by a particular cellular network router or tower (i.e. base station). Moreover, once the merchant terminal is locked to a particular one or more base stations, the base station ID or IDs are sent to the merchant acquirer. For any transaction sought to be made using the merchant terminal through a particular base station, the base station ID of the particular base station is sent with the transaction details (or as part of the transaction details) to the merchant acquirer. The merchant acquirer determines whether the merchant terminal is locked to the base station ID. If so, the usual authorization process takes place. If not, the transaction is declined.

In some embodiments, the merchant terminal will be declined access to the non-permitted base station for any purpose except to check whether the merchant terminal is permitted to make transactions using the non-permitted base station. In other embodiments, the merchant terminal may be permitted access to the non-permitted base station for purposes other than making transactions. For example, it may be possible for a merchant terminal to obtain software updates or to perform functionality tests with a non-permitted base station. This may occur where the merchant terminal is being serviced or repaired at premises other than those of the merchant, or otherwise at premises from which there is no access to a permitted base station.

More than one terminal ID can be associated with any station ID in the database. Similarly, each terminal ID may have one, or more than one, permitted station ID with which it is associated. The relationship between merchant terminals and permitted base stations need not be one-to-one. It may instead be many to one, or one to many, or both.

Step 104 involves sending, via the merchant terminal to an available base station, a request to make a transaction over the wireless network through the available base station (an access request). A base station is an available base station when the merchant terminal is within range of the base station.

The access request comprises the terminal ID. This enables identification of the merchant terminal making the request. The access request may also comprise other information, such as payment vehicle information (e.g. credit or debit card number or a token which maps to such a number, or a digital wallet identifier) and transaction details such as the price of the basket being purchased.

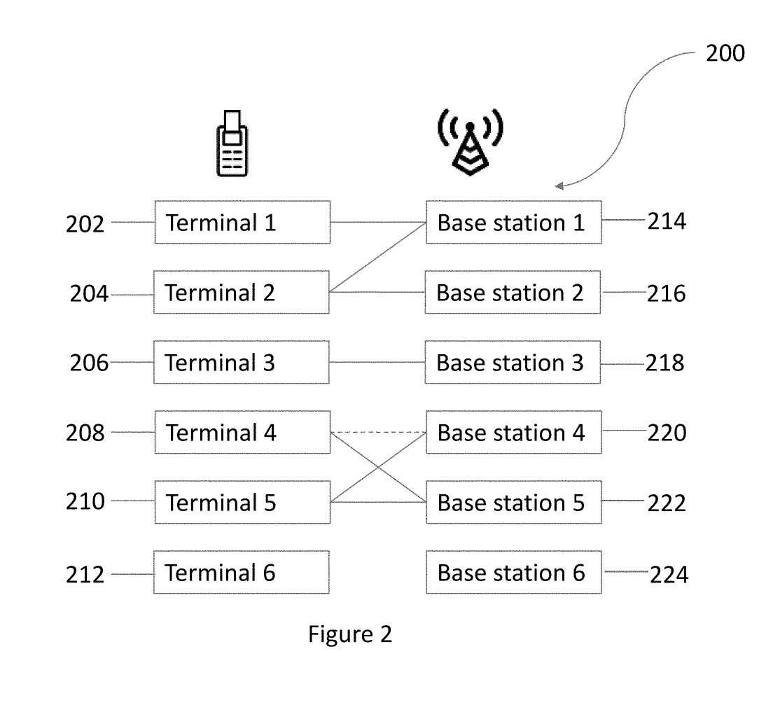

The access request can be sent via the available base station to, for example, a server that manages the database discussed with reference to FIG. 2. The server then performs determining step 106.

The access request may comprise the ID of the available base station, the ID of one or more of the permitted base stations, or both. This information may be contained in the request at the time it is originated by the merchant terminal. Alternatively, some of the information may be added to the request as it is transmitted. Where the base station IDs of one or more permitted base stations are in the request at the time it is sent from the merchant terminal, the available base station may check whether its base station ID matches at least one of the permitted base station IDs. If a match is found then the merchant terminal is permitted to make the transaction via the available base station. If no match is found then the available base station may discard the request. It may, however, be impractical for an available base station to provide such processing capabilities. Thus, in other embodiments, the merchant terminal may send the access request and once the available base station receives the access request from the merchant terminal the available base station adds its base station ID to the access request. The available base station then forwards the access request to the server for comparison with the at least one permitted station IDs of base stations through which the merchant terminal is permitted to make transactions. In a further embodiment, where the merchant terminal knows the base station ID of the available base station, the access request sent from the merchant terminal may already comprise the ID of the available base station.

The access request may be sent when a transaction is desired to be made. When a purchaser endeavours to make a purchase with a vendor and the vendor present a mobile POS terminal, the mobile POS terminal may need to register with the base station, and thus with the mobile network and payment network accessible through that base station, in order to make the transaction. Thus the request is sent when the transaction is initiated at the merchant terminal.

Access to the base station for the purpose of making a transaction may also be deactivated upon completion of the transaction, whether it is successfully settled or declined. This means the merchant register will need to send a new request for each transaction. Access may alternatively be granted once, provided the merchant terminal remains communicatively connected with the base station.

The access request may be sent before any transaction is initiated, to enable a future transaction to be made. For example, the merchant terminal may request access to the base station for the purpose of making a transaction, in anticipation of a customer seeking to purchase a product. This may occur, for example, at the start of the merchant's working day so that the request does not cause unnecessary delays when a transaction is ultimately initiated.

Step 106 involves determining if the available base station has a permitted station ID stored in association with the terminal ID. Once the request is sent from the merchant terminal to the available base station, the available base station forwards the request to a server in communication with the wireless network. The forwarded request includes the station ID of the available base station. The server then queries the database in which the merchant ID and permitted station ID(s) are stored.

If that query shows the station ID of the available base station is one of the one or more permitted station IDs, then a confirmation message is sent to the merchant terminal via the available base station—step 108a. The merchant terminal may then continue with, or initiate, the transaction over the wireless network using the available base station.

If that query shows the station ID of the available base station is not one of the one or more permitted station IDs, then a declination message is sent to the merchant terminal via the available base station—step 108b. The merchant terminal is then prevented from continuing with, or otherwise making, transactions over the wireless network using the available base station.

Notably, if a declination message is received, it does not necessarily mean the merchant terminal cannot make transactions over the wireless network. It instead means the merchant terminal cannot make transactions over the wireless network using the particular available base station through which the request was made. The merchant terminal may still travel to other base stations (or nodes) of the wireless network and request access through each of the other base stations for the purpose of making transactions.

FIG. 2 is a schematic example of a database 200 for storing permitted base station information for a number of merchant terminals. For each terminal 202, 204, 206, 208, 210, 212 at least one base station 214, 216, 218, 220, 222, 224 is a permitted base station. For each terminal 202, 204, 206, 208, 210, 212 the terminal ID is stored in the database. Similarly, for each base station 214, 216, 218, 220, 222, 224 the base station ID is stored in the database 200. The terminal ID and base station ID may be purely numerical, or may comprise alphanumeric characters.

FIG. 2 illustrates that any terminal can be associated with any number of base stations. Similarly, any base station can be associated with any number of terminals. For example, terminals 202 and 206 are each associated with only one base station 214, 218 respectively. Thus base station 214 is a permitted base station for terminal 202. Where base station 218 is similarly only associated with a single terminal 206, base station 214 is associated with, and is thus a permitted base station for, two terminals 202, 204.

Similarly, terminals 204 and 210 each have two permitted base stations 214, 216 and 220, 222 respectively.

Terminal 208 was previously associated with base station 220. The line extending from terminal 208 to base station 220 is shown in broken lines as terminal 208 is now associated only with base station 222. In other words, the associations between terminals and base stations can be updated to facilitate use of terminals in different locations. However, the terminal is limited to being used at only those base stations that are permitted base stations for the respective terminal at the time a transaction is to be initiated.

Terminal 212 is not yet associated with any base stations. This may occur, for example, where terminal 212 is a new or is being serviced, to ensure no transactions are placed. Similarly base station 224 is not associated with any terminals. This may occur where base station 224 is a new base station or may be in an area having no retail or commercial premises.

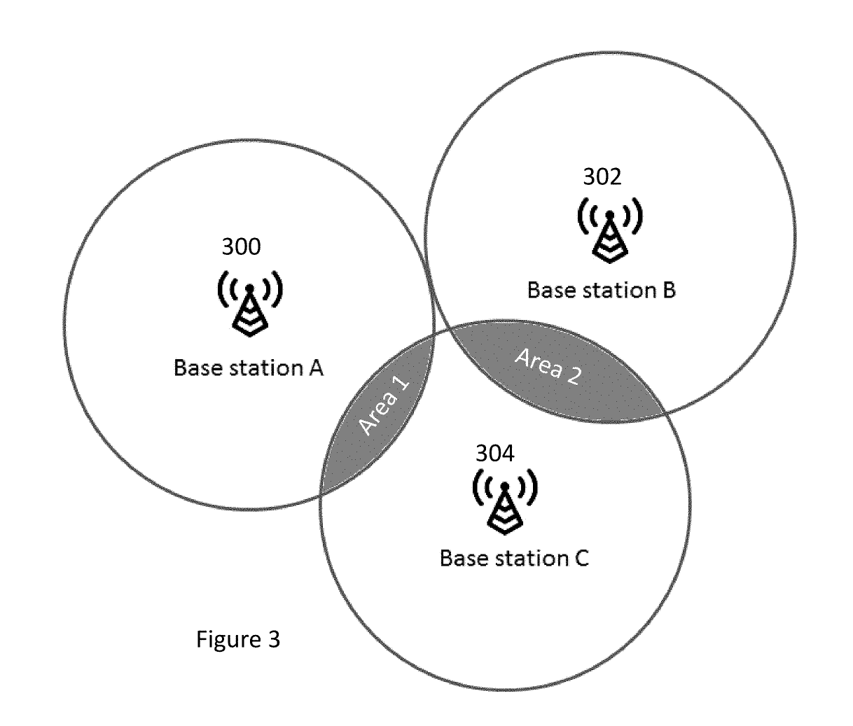

FIG. 3 provides an illustrative example of the availability of base stations relative to the location of a terminal. Each base station 300, 302, 304 is centred in a respective circular reception region. The circular reception regions delineate the area in which a terminal can communicate with the respective base station 300, 302, 304 and is thus within range of the base station 300, 302, 304. In other words, a terminal will have reception to access a telecommunications network via the respective base station 300, 302, 304 when within the respective circular region. When a terminal is located outside the circular reception region then it cannot communicate with the telecommunications network through the respective base station. Such terminals are thus out of range of the respective base station.

A terminal may communicate with the telecommunications network through a particular base station only when the terminal is within range of that base station. As such, by limiting the number of base stations through which a terminal can communicate with the telecommunications network, use of the terminals is geographically limited.

Terminals located in shaded Area 2 can communicate with the telecommunications network via two base stations 302, 304. Thus base stations 302, 304 are the “available base stations” for a terminal located in Area 2. Similarly, base stations 300, 302 are the available base stations for terminals located in Area 1. When a terminal is located in Area 2, a transaction may be made using that terminal, over the telecommunications network, provided that one of base stations 302, 304 is a permitted base station for that terminal. If neither one of base stations 302, 304 is a permitted base station for that terminal, then access to the telecommunications network will be denied for the purpose of making transactions. In an alternative embodiment, the terminal may prompt a user to confirm registration of the terminal on one or more base stations that are within range. This may update the database entries as shown in FIG. 2, for the terminal. Once a new base station has been registered for the terminal in this manner, a server communicating with the database cause removal of the association between the terminal and the one or more base stations with which it was previously associated. Thus the terminal can be used in a roaming manner between geographical locations, but the geographical location for each transaction made using the terminal will be known to be within range of the base station in association with which the terminal was registered at the time of the transaction.

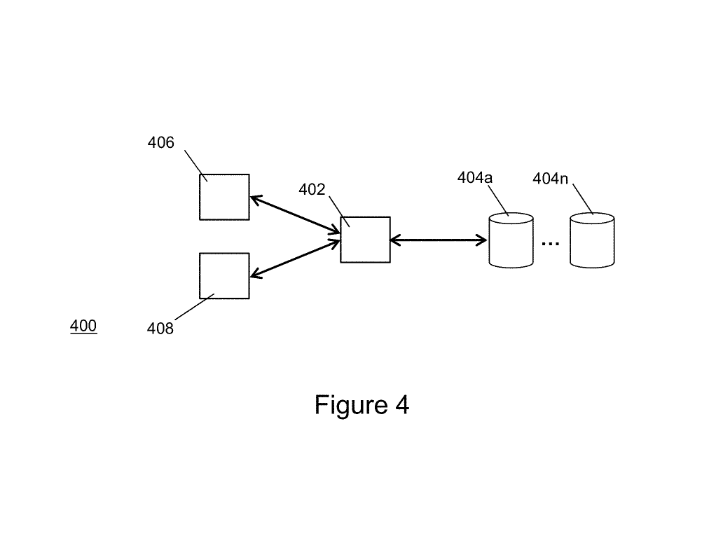

FIG. 4 shows a schematic of a network-based system 400 for controlling permission for making transactions over a wireless network according to an embodiment of the invention. The system 400 comprises a computer 402, one or more databases 404a . . . 404n, and user input modules 406, 408. The computer 402 may be the server of the host of a mobile telecommunications network over which transactions can be made using merchant terminals such as POS machines. Each of the one or more databases 404a . . . 404n is communicatively coupled with the computer 402. One user input module 406 may comprise a computer system through which a terminal is registered in association with one or more base stations. The other user input module 408 may comprise a merchant terminal such as a POS or roaming POS terminal. The user input modules 406, 408 may be separate and distinct modules communicatively coupled with the computer 402. Alternatively, the user input module 406 and user input module 408 may be integrated within a single electronic device (e.g. a roaming POS terminal). The electronic device may have appropriate communication modules for wireless communication with the computer 402 via existing communication protocols.

The computer 402 may comprise: at least one processor; and at least one memory including computer program code; the at least one memory and the computer program code configured to, with at least one processor, cause the computer at least to:

(A) register, in a database:

a terminal identifier (terminal ID) of a merchant terminal; and, in association with the terminal ID,

a permitted base station identifier (permitted station ID) for each of one or more permitted base stations through which the merchant terminal may make transactions;

(B) send, from the merchant terminal to an available base station, a request to access the available base station to make a transaction over the wireless network, the request comprising the terminal ID;

(C) determine if the available base station has a permitted station ID stored in association with the terminal; and

(D1) if so, permit the merchant terminal to access the available base station to make the transaction; or

(D2) if not, deny the merchant terminal access to the available base station for the purpose of making the transaction.

In Step (A), the term “register” effectively means that the terminal ID is stored or recorded in a database and is linked with one or more permitted base stations. The permitted base stations may be hardcoded into the merchant terminal and sent as, for example, standard private data element 63 of an ISO8583-formatted message in a standard telecommunications protocol. The hardcoding may occur when an engineer installs the merchant terminal. Thus the merchant terminal may be hardcoded for use only at a particular base station or base stations upon installation of the terminal. The merchant may then change the permitted base station or base stations, by sending a request to host computer 402. That request may be sent either from merchant terminal 408, or from the other input device 406 which may be, for example, a desktop computer or laptop.

Steps (B), (C) and (D1) may be performed at various times with reference to the time at which a basket is inputted into the terminal—this occurs, for example, when a POS terminal scans one of more products for purchase (the “basket” for purchase, which may also include items such as postage or delivery charges, goods and services tax and other transaction items) or the one or more products are manually keyed into the terminal. In a pre-approval scenario, when a terminal connects to an available base station—such as when powering up the terminal—it may automatically attempt to gain pre-approval or permission to make transactions through that base station. Thereafter, any transactions sought to be made by that terminal through the respective base station will not need to undergo Steps (B), (C) and (D1).

In another example, the request under Step (B) may be sent from the merchant terminal to the available base station after inputting the basket into the merchant terminal. Sending the request may occur once provided the merchant terminal remains in communication (i.e. within range) of the available base station. Thus the permission process of Steps (C) and (D1) need only occur once. Alternatively, Steps (B), (C) and (D1) or (D2) may be undertaken each time a transaction is intended to be made.

Where the available base station recited in Step (B) is one of at least two available base stations, the at least one memory and the computer program code may be further configured to, with at least one processor, cause the computer to (E) send a request to two or more of the at least two available base stations. Thus the terminal can be permitted to make transactions through more than one base station. The choice of available, permitted base station through which a particular transaction is made may then be governed by standard telecommunications protocols—for example, the base station with the strongest signal (e.g. that which is nearest the terminal) may be used.

To facilitate Step (E), the at least one memory and the computer program code may be further configured to, with at least one processor, cause the computer to determine, for each of the two or more accessible base stations, whether the respective accessible base station is stored in association with the terminal ID. Thus Step (D1) would comprise permitting access of the merchant terminal to make the transaction through one of the two or more accessible base stations, if said one of the two or more accessible base stations is stored in association with the terminal ID.

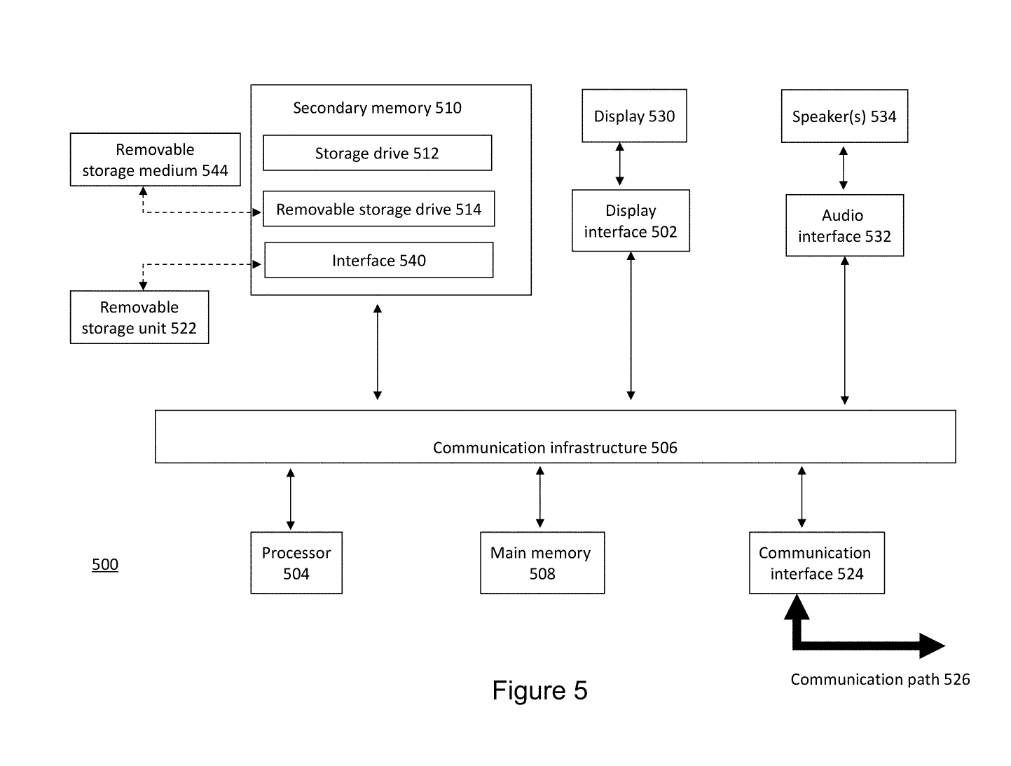

FIG. 5 depicts an exemplary computer/computing device 500, hereinafter interchangeably referred to as a computer system 500, where one or more such computing devices 500 may be used to facilitate execution of the above-described method for controlling permission for making transactions over a wireless network. In addition, one or more components of the computer system 500 may be used to realize the computer 402. The following description of the computing device 500 is provided by way of example only and is not intended to be limiting.

As shown in FIG. 5, the example computing device 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a telecommunications network, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 544 in a well-known manner. The removable storage medium 544 may include magnetic tape, optical disk, non-volatile memory storage medium, or the like, which is read by and written to by removable storage drive 514. As will be appreciated by persons skilled in the relevant art(s), the removable storage medium 544 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 540. Examples of a removable storage unit 522 and interface 540 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 540 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the inventions, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port (such as a serial, parallel, printer, GPIB, IEEE 1393, RJ44, USB), an antenna with associated circuitry and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 544, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the storage drive 512, or the interface 540. Alternatively, the computer program product may be downloaded to the computer system 500 over the communications path 526. The software, when executed by the processor 504, causes the computing device 500 to perform functions of embodiments described herein.

It is to be understood that the embodiment of FIG. 5 is presented merely by way of example. Therefore, in some embodiments one or more features of the computing device 500 may be omitted. Also, in some embodiments, one or more features of the computing device 400 may be combined together. Additionally, in some embodiments, one or more features of the computing device 500 may be split into one or more component parts.

It is to be understood that the embodiment of FIG. 5 is presented merely by way of example. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

It will be appreciated that the elements illustrated in FIG. 5 function to provide means for performing the computer implemented method as described with respect to FIG. 1. For example, the computing device 500 provides an apparatus for performing a method for controlling permission for making transactions over a wireless network, the apparatus comprising: at least one processor 504, at least one memory 508 including computer program code and at least one communication interface 524.

The at least one memory 508 and the computer program code are configured to, with at least one processor 504, cause the apparatus at least to: register, in a database: a terminal identifier (terminal ID) of a merchant terminal; and, in association with the terminal ID, a permitted base station identifier (permitted station ID) for each of one or more permitted base stations through which the merchant terminal may make transactions; sending, from the merchant terminal to an available base station, a request to access the available base station to make a transaction over the wireless network, the request comprising the terminal ID; determining if the available base station has a permitted station ID stored in association with the terminal ID; and if so, permitting the merchant terminal to access the available base station to make the transaction; or if not, denying the merchant terminal access to the available base station for the purpose of making the transaction.

The computing device 500 of FIG. 5 may execute the process shown in FIG. 1 when the computing device 500 executes instructions which may be stored in any one or more of the removable storage medium 544, the removable storage unit 522 and storage drive 512. These components 522, 544 and 512 provide a non-transitory computer readable medium having stored thereon executable instructions for controlling a computer to perform steps comprising: registering, in a database: a terminal identifier (terminal ID) of a merchant terminal; and, in association with the terminal ID, a permitted base station identifier (permitted station ID) for each of one or more permitted base stations through which the merchant terminal may make transactions; sending, from the merchant terminal to an available base station, a request to access the available base station to make a transaction over the wireless network, the request comprising the terminal ID; determining if the available base station has a permitted station ID stored in association with the terminal ID; and if so, permitting the merchant terminal to access the available base station to make the transaction; or if not, denying the merchant terminal access to the available base station for the purpose of making the.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer network for controlling permission for making transactions over a wireless network, the computer network comprising:
a database; and
a merchant terminal; and
an available base station in communication with the merchant terminal,
the database being associated with a processor, and the merchant terminal and available base station each comprising:
at least one processor; and
at least one memory including computer program code;
the computer program code of the merchant terminal and the available base station collectively configure the computer network to, with the respective at least one processor:
register, in the database:
a terminal identifier (terminal ID) of the merchant terminal;
and, in association with the terminal ID,
a permitted base station identifier (permitted station ID) for each of one or more permitted base stations through which the merchant terminal may make transactions;
send, from the merchant terminal via the available base station, a request to make a transaction over the wireless network, the request comprising the terminal ID and an ID of the available base station;
determine if the ID of the available base station matches at least one permitted station ID stored in association with the terminal ID; and
if so, permit the merchant terminal to make the transaction.

2. A network according to claim 1, wherein the computer program code is further configured to cause the computer network to receive input, into the merchant terminal, of a basket for purchase.

3. A computer network according to claim 2, wherein the request is sent from the merchant terminal to the available base station after receiving input of the basket into the merchant terminal.

4. A computer network according to claim 2, wherein the request is sent from the merchant terminal to the available base station in advance of receipt of input of the basket into the terminal.

5. A computer network according to claim 1, wherein the merchant terminal is a mobile terminal.

6. A computer network according to claim 1, wherein the available base station is one of at least two available base stations, the computer program code further configuring the computer network to send a request via two or more of the at least two available base stations.

7. A computer network according to claim 6, wherein the computer program code further configures the computer network to determine, for each of the two or more accessible base stations, whether the respective accessible base station is stored in association with the terminal ID.

8. A computer network according to claim 7, wherein the computer program code further configures the computer network to permit access of the merchant terminal to make the transaction through one of the two or more accessible base stations, if said one of the two or more accessible base stations is stored in association with the terminal ID.

9. A computer-implemented method for controlling permission for making transactions over a wireless network, comprising:
registering, in a database:
a terminal identifier (terminal ID) of a merchant terminal;
and, in association with the terminal ID,
a permitted base station identifier (permitted station ID) for each of one or more permitted base stations through which the merchant terminal may make transactions;
sending, via the merchant terminal to an available base station, a request to make a transaction over the wireless network, the request comprising the terminal ID and an ID of the available base station;
determining if the ID of the available base station matches at least one permitted station ID stored in association with the terminal ID; and
if so, permitting the merchant terminal to make the transaction.

10. A computer-implemented method according to claim 9, further comprising receiving input, into the merchant terminal, of a basket for purchase.

11. A computer-implemented method according to claim 10, wherein the request is sent from the merchant terminal to the available base station after receiving input of the basket into the merchant terminal.

12. A computer-implemented method according to claim 10, wherein the request is sent from the merchant terminal to the available base station in advance of receipt of input of the basket into the terminal.

13. A computer-implemented method according to claim 9, wherein the merchant terminal is a mobile terminal.

14. A computer-implemented method according to claim 9, wherein the available base station is one of at least two available base stations, the computer process further comprising sending a request via two or more of the at least two available base stations.

15. A computer-implemented method according to claim 14, further comprising determining, for each of the two or more accessible base stations, whether the respective accessible base station is stored in association with the terminal ID.

16. A computer-implemented method according to claim 15, further comprising permitting access of the merchant terminal to make the transaction through one of the two or more accessible base stations, if said one of the two or more accessible base stations is stored in association with the terminal ID.

17. An acquirer processing system for controlling permission for making transactions over a wireless network, comprising:
a database; and
at least one processor;
wherein the at least one processor is configured to:
register, in the database:
a terminal identifier (terminal ID) of a merchant terminal;
and, in association with the terminal ID,
a permitted base station identifier (permitted station ID) for each of one or more permitted base stations through which the merchant terminal may make transactions;
receive, from the merchant terminal via an available base station, a request to make a transaction over the wireless network, the request comprising the terminal ID and an ID of the available base station;
determine if the ID of the available base station matches at least one permitted station ID stored in association with the terminal ID; and
if so, permit the merchant terminal to make the transaction.

18. An acquirer processing system according to claim 17, wherein the merchant terminal is a mobile terminal.

19. An acquirer processing system according to claim 18, wherein the available base station is one of at least two available base stations, and wherein the at least one processor is further configured to receive requests from the merchant terminal via two or more of the at least two available base stations.

20. An acquirer processing system according to claim 19,
wherein the at least one processor is further configured to determine, for each of the two or more accessible base stations, whether the respective accessible base station is stored in association with the terminal ID,
wherein the at least one processor is further configured to permit access of the merchant terminal to make the transaction through one of the two or more accessible base stations, if said one of the two or more accessible base stations is stored in association with the terminal ID.
